(19) United States
(12) Patent Application Publication
(10) Pub. No.: US 2026/0037990 A1
(43) Pub. Date: Feb. 5, 2026

(54) SYSTEMS AND PROCESSES FOR SCREENING FOR AFFILIATIONS

(71) Applicant: Vital4Data, LLC, Marietta, GA (US)

(72) Inventors: Kellan Williams, Granville, OH (US); Michael Franks, Dallas, GA (US)

(21) Appl. No.: 19/036,403

(22) Filed: Jan. 24, 2025

Related U.S. Application Data
(60) Provisional application No. 63/679,374, filed on Aug. 5, 2024.

(51) Int. Cl. G06Q 30/018; G06Q 10/0635; G06Q 50/26

(52) U.S. Cl. CPC G06Q 30/018; G06Q 10/0635; G06Q 50/26

(57) ABSTRACT

An association screening system for automatically processing and analyzing vast amounts of unstructured data to provide accurate, contextually relevant association screening may utilize one or more computing devices equipped with processors to conduct precise, contextually relevant screenings for affiliations with entities such as state-owned enterprises (SOEs) and non-governmental organizations (NGOs).

### CROSS-REFERENCE TO RELATED APPLICATIONS

This application claims the benefit of, and priority to, U.S. Provisional Patent Application No. 63/679,374, filed Aug. 5, 2024, and entitled “SYSTEMS AND PROCESSES FOR SCREENING FOR AFFILIATIONS,” which is hereby incorporated in its entirety as if set forth herein.

### TECHNICAL FIELD

The present disclosure relates generally to the field of data processing and analytics, specifically to systems and processes for screening individuals for associations with state-owned enterprises (SOEs) and non-governmental organizations (NGOs).

### BACKGROUND

In the rapidly evolving digital landscape, the ability to efficiently identify and assess the affiliations of individuals with various entities, particularly SOEs and NGOs, has become crucial for compliance and risk management. Traditional methods often rely on static, manually curated databases that do not reflect real-time changes and can be cumbersome and costly to maintain. Furthermore, the increasing volume and complexity of data from diverse sources present significant challenges in ensuring accuracy and timeliness of information, necessitating more advanced solutions.

Conventional systems typically involve keyword-based searches within limited datasets, which often yield high volumes of irrelevant results or false positives due to the lack of contextual understanding and dynamic updating capabilities. Moreover, the expanding global regulations on anti-money laundering (AML) and Know Your Customer (KYC) processes underscore the need for enhanced methods that can adapt to new data and regulatory requirements efficiently.

Additionally, the manual processes involved in verifying the connections between individuals and organizations, such as SOEs and NGOs, are labor-intensive and prone to errors. These challenges are compounded by the subtleties of language and terminology used across the globe and different jurisdictions, which can vary significantly and affect the accuracy of traditional screening tools.

Accordingly, there is an unresolved need for systems and methods that can timely, accurate, and contextually relevant screening for affiliations.

### SUMMARY

Briefly described, and in various aspects, the present disclosure generally relates to data analytics, particularly in the context of compliance and risk management. Moreover, the present disclosure is particularly relevant to systems and methods for automated processing and analysis of vast amounts of unstructured data to conduct precise, contextually relevant screenings for affiliations with entities such as SOEs and NGOs. These systems and methods may address challenges associated with immense volumes of data generated daily, which may contain critical information pertinent to the reputational and regulatory risks associated with individuals and entities. Moreover, the systems and methods may provide timely, accurate, and contextually relevant screening for affiliations, enhancing compliance measures and risk management processes.

According to some aspects, a system including one or more computing devices equipped with processors may leverage a combination of natural language processing (NLP) and text link analysis to extract and analyze data from a wide range of media sources. The text link analysis may include creating relational graphs that visually or conceptually map connections between entities and individuals, providing a clear depiction of affiliations. A database of known entities (e.g., SOEs and NGOs) may be accessed and media articles may be scanned to identify references to the entities along with associated individuals and their roles. Moreover, digital media articles may be parsed using deep learning techniques, refining the accuracy of data concerning individuals and their positions associated with entities.

The veracity of the associations between the entities and individuals may be determined and a profiled database may be updated with the associations and any related information. For example, one or more associations between entities and individuals may be tagged in the profiled database. The database may be dynamic, capable of triggering alerts when changes in the status of an association are detected, ensuring that all data remains current and actionable. Screening queries associated with measuring compliance and risk of individuals or entities may be received. In response to the screening queries, the disclosed systems and methods may provide detailed indications of entities or individuals, incorporating information such as the position associated with the individual. According to some aspects, geopolitical risks may be assessed to determine a geopolitical risk factor based on the locations associated with the entities or individuals. The geopolitical risk factor may influence the indications provided in response to screening queries. For example, the geopolitical risk factor may be used to determine one or more individuals or entities.

The disclosed systems and methods may integrate with external compliance systems to facilitate collaborative risk management, e.g., in the context of global regulatory environments that require adherence to AML and KYC standards. By automatically updating a database in real-time or at predetermined intervals, the disclosed systems and methods may quickly adapt to new data, providing timely, accurate, and contextually relevant screenings. Moreover, deep learning techniques and machine learning models may be used to analyze historical data patterns to assess the likelihood of ongoing associations or potential conflicts of interest, thereby providing a robust solution to the technical problems associated with traditional, manual screening processes.

The disclosed systems and processes represent a significant technological advancement in the field of data processing and analytics, specifically tailored for screening individuals for associations with SOEs and NGOs. By automating complex data analysis tasks and integrating advanced machine learning and natural language processing technologies, the disclosed systems and methods address the need for more efficient, accurate, and timely screening methods in compliance and risk management, thereby solving the technical problems associated with outdated, labor-intensive, and error-prone traditional methods.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to limitations that solve any or all disadvantages noted in any part of this disclosure.

### BRIEF DESCRIPTION OF THE FIGURES

Reference will now be made to the accompanying drawings, which are not necessarily drawn to scale.

FIG. 1 illustrates an example of an environment for an affiliation screening system;

FIG. 2 illustrates an example of one or more affiliation screening modules;

FIG. 3 illustrates an example of a process for association screening;

FIG. 4 illustrates an example of a process for association screening;

FIG. 5 illustrates a schematic of an example of an association screening device; and

FIG. 6 illustrates an example diagrammatic representation of a machine in the form of a computer system.

In accordance with common practice, the various features illustrated in the drawings may not be drawn to scale. Accordingly, the dimensions of the various features may be arbitrarily expanded or reduced for clarity. In addition, some of the drawings may not depict all of the components of a given system, method, or device. Finally, like reference numerals may be used to denote like features throughout the specification and figures.

### DETAILED DESCRIPTION

For the purpose of promoting an understanding of the principles of the present disclosure, reference will now be made to the embodiments illustrated in the drawings and specific language will be used to describe the same. It will, nevertheless, be understood that no limitation of the scope of the disclosure is thereby intended; any alterations and further modifications of the described or illustrated embodiments, and any further applications of the principles of the disclosure as illustrated therein are contemplated as would normally occur to one skilled in the art to which the disclosure relates. All limitations of scope should be determined in accordance with and as expressed in the claims.

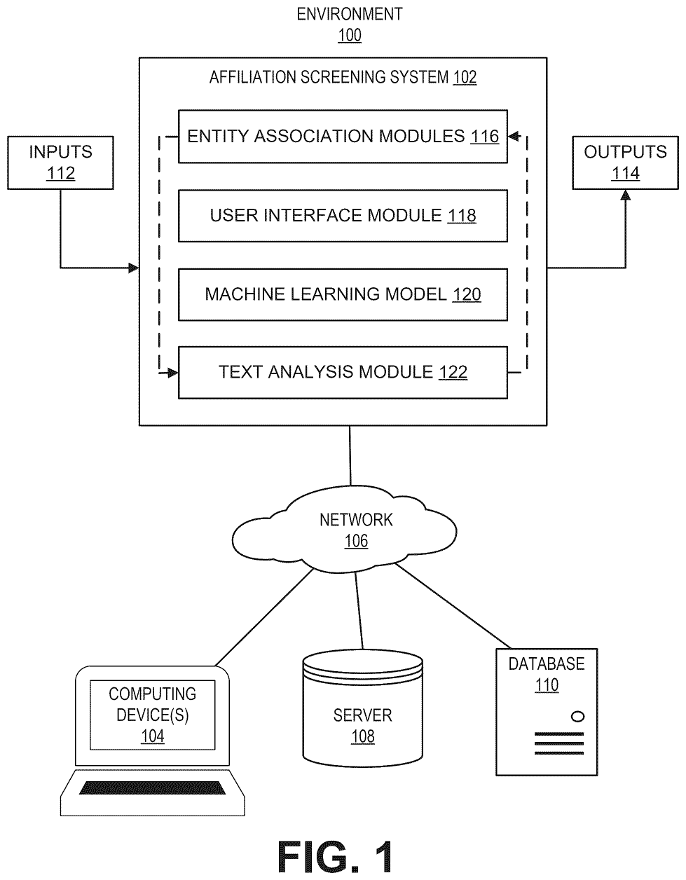

Referring now to the figures, for the purposes of example and explanation of the processes and components of the disclosed systems and methods, reference is made to FIG. 1, which illustrates an environment 100 for an affiliation screening system 102 for screening individuals for associations with entities (e.g., SOEs and NGOs). The affiliation screening system 102 may facilitate compliance and risk management. Moreover, the affiliation screening system 102 may address the challenges inherent in managing vast amounts of unstructured data, ensuring timely, accurate, and contextually relevant information is available for decision-making processes.

The affiliation screening system 102 may utilize advanced data processing capabilities, including NLP and text link analysis, to analyze and extract data from a wide range of media sources. The affiliation screening system 102 may identify the associations individuals have entities as well as the roles they occupy, providing comprehensive insights essential for compliance reviews and/or measuring risk.

The affiliation screening system 102 may analyze a diverse array of media sources to ensure comprehensive and accurate screening for associations with entities. For example, the affiliation screening system may process information from traditional news outlets (e.g., major newspapers such as The New York Times, The Guardian, or The Washington Post) which provide extensive coverage of international and domestic events that might influence measurement or quantification of compliance and risk. The affiliation screening system 102 may analyze publications from digital media platforms such as online news portals (e.g., Reuters or CNBC) which may offer real-time updates and in-depth analysis on a wide range of topics pertinent to regulatory compliance. Specialized publications also play a crucial role, with industry-specific magazines like Forbes and Bloomberg offering insights into economic trends and corporate affairs that could signal potential risks or associations worth investigating. The system further extends its reach to academic journals available through repositories like JSTOR, where scholarly articles provide detailed reports that can shed light on less obvious affiliations or historical data relevant to an individual or entity. Moreover, the affiliation screening system 102 may harness the power of social media platforms, including Twitter and LinkedIn, where individuals and organizations may frequently share updates that might reflect on their networks and affiliations. Blogs and opinion pieces, often found on independent websites or media platforms like Medium, may be scrutinized for nuanced perspectives or detailed commentary that may indicate underlying connections not evident in mainstream media.

By integrating data from varied sources, the affiliation screening system may provide an analysis that includes current information and encompasses a broad spectrum of perspectives and content types. This holistic approach may provide a more nuanced understanding of the affiliations and potential compliance risks associated with individuals and entities, enhancing the effectiveness of the screening processes.

The affiliation screening system 102 may address technical challenges associated with managing and interpreting vast amounts of unstructured data. For example, sophisticated data processing technologies may streamline the extraction and analysis of relevant information from the diverse array of digital media sources. By employing advanced NLP algorithms, the affiliation screening system 102 may parse through extensive textual data, identifying key terms and phrases that indicate an individual's association with SOEs or NGOs. For example, the affiliation screening system 102 may use text link analysis to construct relational graphs that visually and conceptually map the connections between individuals and entities. According to some aspects, the NLPs may address the technical problem of relational ambiguity in unstructured data, where traditional keyword searches might fail. By analyzing the context in which names and organizational references appear, the affiliation screening system 102 may discern substantive connections from incidental mentions, thereby reducing false positives (a common issue in compliance checks).

Moreover, the affiliation screening system 102 may update database(s) in real-time as new data becomes available. The updates may address inaccuracies or missing data resulting from data obsolescence in rapidly changing regulatory environments. For instance, if an NGO becomes sanctioned or an individual's status as a politically exposed person (PEP) changes, the affiliation screening system 102 may immediately reflect this in one or more reports, providing compliance officers with access to the most current information. Additionally, the affiliation screening system 102 may utilize machine learning models to continuously learn from new data inputs and user feedback to improve the accuracy and relevance of the screening outcomes, demonstrating an adaptive response to the evolving nature of data patterns and regulatory requirements. For example, if an individual has previously served on the board of several NGOs, the system may predict potential future associations with similar entities. This predictive capability may facilitate proactive compliance and risk management, allowing organizations to anticipate and address potential issues before they arise.

The affiliation screening system 102 may integrate with external compliance management systems, facilitating a unified approach to measurement of risk and regulatory reporting. External compliance management systems may include software solutions or platforms used by organizations to ensure they adhere to regulatory requirements, industry standards, and internal policies. The external compliance management systems may include Anti-Money Laundering (AML) systems, Know Your Customer (KYC) systems, regulatory compliance management systems, fraud detection systems, or Enterprise Risk Management (ERM) systems. This integration with external compliance management systems may allow for seamless data flow and consolidated risk management processes, ensuring that all compliance-related data points are coherently tracked and assessed across platforms. For example, if a compliance query identifies a high-risk association, the affiliation screening system 102 may automatically initiate a detailed risk measurement protocol, pulling in additional data from connected systems to provide a comprehensive risk profile.

According to some aspects, the affiliation screening system 102 may access a dynamically updated database of known SOEs and NGOs. Utilizing a combination of NLP and text link analysis, the affiliation screening system 102 may scan through a multitude of media articles to extract references to these entities. The affiliation screening system 102 may identify associated individuals and their roles within these organizations, verifying the authenticity of such associations and updating a profiled database accordingly. For example, one or more associations between entities and individuals may be tagged in the profiled database. The database may trigger alerts whenever there is a change in the status of an association, ensuring that the affiliation screening system 102 is informed of the most current information.

Moreover, the affiliation screening system 102 may respond to specific queries by providing indications of the entities involved. The indications may include information about the positions associated with individuals within the entities. Integration of the affiliation screening system 102 with external compliance systems may facilitate a cohesive and collaborative approach to managing regulatory requirements across various platforms. The affiliation screening system 102 may also assess geopolitical risks (e.g., determining a geopolitical risk factor based on the locations associated with the entities or individuals) that could influence the context of the associations.

Affiliation screening modules 116 may include one or more modules designed to execute various functions for the process of screening individuals for associations with entities such as SOEs and NGOs. Each module may handle specific aspects of the screening process, leveraging advanced data processing capabilities to enhance efficiency and accuracy.

A module of the affiliation screening modules 116 may access and manage a dynamic database of known entities. The module may regularly update and maintain the database of known entities with information from a variety of public and proprietary sources, keeping the data current and comprehensive. For example, the module may integrate data from global financial regulatory lists, corporate records, and legal filings to keep track of newly registered NGOs or changes in the ownership structure of SOEs.

Another module of the affiliation screening modules 116 may use NLP to analyze text data extracted from a range of media sources. The module may scan articles, reports, and other digital content to identify mentions of specific individuals and their potential links to the targeted entities. The module may determine context and discern relevant associations from incidental mentions, thus minimizing false positives. For instance, if a corporate leader is mentioned in the context of a charity event backed by an NGO, the NLP module may evaluate whether the mention suggests an official role within the NGO or merely a one-time participation.

A text link analysis module of the affiliation screening modules 116 may create one or more relational graphs that map out connections between individuals and entities. This visual and conceptual mapping may provide understanding of the nature and strength of associations. For example, the text link analysis module may show that an executive sitting on the boards of several SOEs is also a major donor to an NGO, highlighting potential conflicts of interest or compliance issues. Moreover, one or more of the affiliation screening modules 116 may include real-time alerting mechanisms. When a significant change in an individual's association status is detected, such as a resignation from an NGO board or a new appointment as an SOE executive, the real-time alerting mechanisms may trigger alerts for immediate action or further investigation.

Embodiments of the affiliation screening system 102 may comprise a user interface (UI) module 118 serving as a centralized interactive platform that may enable users to actively engage with the affiliation screening process. The UI module 118 may be designed with user experience in mind, facilitating the exploration, manipulation, and analysis of data concerning associations with entities such as SOEs and NGOs. The UI module 118 may allow users to input queries, view relational graphs, or access detailed profiles and histories of individuals and entities.

The UI module 118 may streamline complex data interactions by presenting information in an organized manner, allowing users to easily navigate through various layers of data. For example, a compliance officer may use the UI to quickly set parameters for a search, review the relationships of a particular individual with one or more entities, and/or access historical data that indicates patterns of association or potential conflicts of interest. Moreover, UI module 118 may display alerts and updates in real-time, ensuring that users receive immediate notifications about significant changes or updates in the status of the entities or individuals being monitored.

By incorporating search filters and data visualization tools, the UI module 118 may allow users to perform targeted searches and interpret the results effectively. The data visualization tools may include dynamic relational graphs that visually map the connections between individuals and entities and/or heat maps that highlight areas of high risk or concern based on the geographic distribution of entities and associated regulatory frameworks. Moreover, the UI module 118 may integrate seamlessly with external compliance and risk management systems, enabling a unified approach to data handling and decision-making. This integration may allow data to flow smoothly between systems, facilitating a comprehensive compliance strategy that leverages up-to-date and accurate information.

Accordingly, the UI module 118 may simplify user interactions with complex datasets and enhance the efficiency and effectiveness of the screening processes. By providing a user-friendly interface that addresses the specific needs of compliance and risk management officers, the UI module 118 may support proactive management of regulatory obligations and risk in a global and often volatile operational landscape.

Connected to the affiliation screening system 102 may be one or more computing devices 104, each of which may vary widely in their design and application but sharing a common capability to process and analyze data. These computing devices 104 may be employed by compliance officers, risk managers, and/or other personnel engaged in due diligence and background checks to conduct screenings for affiliations with various entities across multiple media sources. The one or more computing devices 104 may be interconnected via a network 106, enabling the sharing and transmission of data and analytical results throughout the environment 100. Network 106 may encompass a variety of networking technologies to facilitate the seamless flow of information and ensure the robust operation of the affiliation screening system 102.

A server 108 within the environment 100 may operate as a central processing unit and repository for applications and services related to the systems and methods for the application of one or more of NLP and/or machine learning models for context analysis, and/or databases for entity recognition in the context of affiliation screening. In this capacity, the server 108 may manage the ingestion, processing, and analysis of large volumes of unstructured text data, apply advanced algorithms to determine the presence of entities, and assess the context surrounding these entities to identify potential affiliations.

Upon successful identification and analysis, the server 108 may categorize the data and assign relevance scores, which may be stored and may be queried by users through the UI module 118. The relevance scores may enable users to ascertain a level of risk or importance of the affiliations associated with the identified entities. Moreover, the server 108 may facilitate continuous improvement of screening accuracy by updating the underlying NLP and/or machine learning models based on feedback and new data, implementing adjustments and refinements to the entity resolution and context analysis processes, facilitating evolution of the affiliation screening system 102 in alignment with emerging trends and patterns in data.

Additionally, the server 108 may distribute updates, such as enhanced algorithms, improved linguistic rulesets, and/or expanded entity databases, to computing devices 104 and other components of the affiliation screening system 102. By centrally managing these updates, the server 108 may facilitate cohesive functioning of the affiliation screening system 102, maintaining the highest levels of performance and accuracy in affiliation screening.

A database 110 may serve as a repository for storing and managing data for contextualized entity resolution and analysis in affiliation screening. The database 110 may adopt various forms to address the complex data management needs inherent to the identification and evaluation of entity affiliations. The database 110 may include a relational database organizing structured data with predefined relationships, facilitating retrieval of entities, context analyses, and related information. Moreover, to manage the vast and heterogeneous unstructured data inherent to affiliation screening, the database 110 may include a NoSQL model. The NoSQL model may provide flexibility to accommodate various data types and structures, allowing for scalable data storage that may handle high-velocity and high-volume data influx. According to some aspects, the database 110 may be cloud-based, allowing for data redundancy, and ensuring that data is securely stored and accessible from multiple geographic locations, facilitating seamless access for distributed users and systems, supporting continuous affiliation screening operations.

The database 110 may retain processed information, including identified entities, their associated context scores, and/or the context within which the entities are mentioned in media sources. Moreover, the database 110 may store the results of relevance scoring, which may indicate the strength of association between entities and identified affiliations. Additionally, the database 110 may archive historical search results and user queries, creating a knowledge base that may be used for trend analysis, pattern recognition, and/or refinement of the system's analytical models. Moreover, the database 110 may contain configuration settings and parameters for the entity resolution and association components of the environment 100, allowing for dynamic adjustment to operational aspects of the affiliation screening process. By maintaining this dataset, the database 110 may allow the affiliation screening system 102 to evolve by learning from new data and user feedback, thereby progressively enhancing the accuracy and reliability of the affiliation screening.

Embodiments of the affiliation screening system 102 may comprise a machine learning model 120 trained to analyze patterns and relationships within vast datasets, allowing the affiliation screening system 102 to accurately and reliably identify entities, determine affiliations, associate entities and affiliations, and/or indicate the strength of association between entities and identified affiliations. The machine learning model 120 may adaptively refine its predictions based on new data, enhancing the ability of the machine learning model 120 to provide timely and accurate insights for compliance and risk management purposes.

The training of the machine learning model 120 may begin with data collection and preprocessing, where data from diverse sources such as news articles, social media posts, financial reports, and public records is cleaned and prepared by removing noise and irrelevant information. The processed data may be stored in the database 110. Feature extraction techniques such as Named Entity Recognition (NER) may be utilized to identify and classify entities, assign context scores to determine relevance, and/or calculate relevance scores to quantify the strength of associations. The machine learning model 120 may then be trained using various methods, such as supervised learning. For example, the machine learning model 120 may be trained with labeled datasets from the database 110 and may use algorithms such as Support Vector Machines (SVM), random forest, and Neural Networks to confirm associations between entities and individuals.

Unsupervised learning may be used along with clustering techniques such as K-Means and hierarchical clustering to group similar entities and identify potential associations. Semi-supervised learning may be used to train the machine learning model 120 and may combine labeled and unlabeled data from the database 110 to improve model accuracy. Reinforcement learning may include implementing feedback loops where the machine learning model 120 receives feedback from compliance officers and adjusts its predictions based on this feedback to train the machine learning model 120.

Embodiments of the affiliation screening system 102 may comprise a text analysis module 122 to enhance the precision and accuracy of output 114. For example, the text analysis module 122 may include one or more text analytic platforms (e.g., Rosette). The text analysis module 122 may be integrated to the affiliation screening system 102 via an Application Programming Interface (API). The text analysis module 122 may provide endpoints for various NLP tasks such as entity recognition, sentiment analysis, text categorization, and/or other NLP tasks. Moreover, the text analysis module 122 may provide deep contextual understanding by analyzing relationships between entities and the context in which the entities appear.

In some embodiments, the text analysis module 122 may discern meaningful associations from incidental mentions. For example, the text analysis module 122 may determine that a name mention in an article is incidental and does not have a significant role within the NGO. The integration of the text analysis module 122 may enhance the training of the machine learning model 120 by ensuring only relevant relationships are included in the training data. The text analysis module 122 may serve as an additional layer that weeds out potential outliers from output 114. Moreover, the text analytic platform may support a multitude of languages, enabling the analysis of text data from international sources. Thereby the training dataset may be augmented with multilingual data, enhancing the ability of the machine learning model 120 to generalize text data across different languages and global contexts.

In some embodiments, the text analysis module 122 may enhance the extraction and verification of entity data from diverse text sources. The text analysis module 122 may utilize a sophisticated natural language processing engine, which may systematically identify and extract entities from unstructured text data. The extracted entities may be compared with the entities identified by the affiliation screening modules 116, ensuring consistency and accuracy in entity recognition.

Further, the text analysis module 122 may provide a secondary verification step, where it cross-references the extracted entities against a secondary extraction performed by a different analytical method (e.g., as employed by the affiliation screening modules 116). This dual-layer verification may be used to confirm the accuracy of the initially extracted entities (e.g., from the affiliation screening modules 116) and eliminate any outliers. For example, entities that have been identified by the affiliation screening modules and are not identified by the text analysis module may be eliminated. This secondary verification process may enhance the reliability of the data and refine the overall screening process by reducing the likelihood of false positives or erroneous entity associations.

Evaluation and validation of the machine learning model 120 may be conducted using one or more metrics, such as accuracy, precision, recall, and F1-score, along with cross-validation to ensure generalization. Continuous learning and adaptation may be achieved through real-time updates and feedback loops, where user feedback may refine the machine learning model 120 by retraining with new data and adjusting parameters. Integration with external systems via Application Programming Interfaces (APIs) may facilitate seamless data flow and collaborative risk management, while dynamic adjustment of configuration settings and parameters may ensure the affiliation screening system 102 remains adaptive to real-time data and evolving regulatory requirements.

Inputs 112 into the affiliation screening system 102 may be derived from a broad spectrum of data sources essential for conducting affiliation screenings. For example, the inputs 112 may include real-time data streams capturing up-to-the-minute news articles, social media posts, financial reports, online articles, public filings, court transcripts, legal documents, etc., alongside structured and unstructured databases that aggregate historical media content, corporate records, and various compliance lists. Additionally, the inputs 112 may include user-generated queries, such as specific names, keywords, or phrases related to entities of interest. This multifaceted data collection may allow the affiliation screening system 102 to perform a comprehensive scan of available information, ensuring that the affiliation screening is both current and historically aware.

Outputs 114 from the affiliation screening system 102 may include results from the affiliation screening process, e.g., providing users with precise and actionable information. The outputs 114 may be tailored to the specific needs of compliance and risk management procedures. For example, detailed reports and analytical summaries may provide users with deep insights into the context and associations associated with each of the identified entities. Moreover, reports may guide tactical decision-making and risk measurements by highlighting potential affiliations, enabling organizations to proactively manage and mitigate reputational and compliance risks.

Additionally, the outputs 114 may include alerts and notifications to inform users of critical findings. The alerts may vary in format (e.g., from emails and push notifications to interactive dashboards within the system's user interface) and may convey the urgency and relevance of the findings. The outputs 114 may allow compliance officers and risk managers to quickly assess and respond to potential risks. The outputs 114 may also include visualization tools that map entities and their connections to identified affiliations, offering a clear and intuitive understanding of the data relationships. Such visual outputs may simplify complex data sets, making them easily interpretable and actionable. To enhance operational efficiency, the alerts and visualizations may be prioritized based on predefined criteria such as the severity of the risk or the relevance score, allowing the most significant issues to be addressed promptly and effectively.

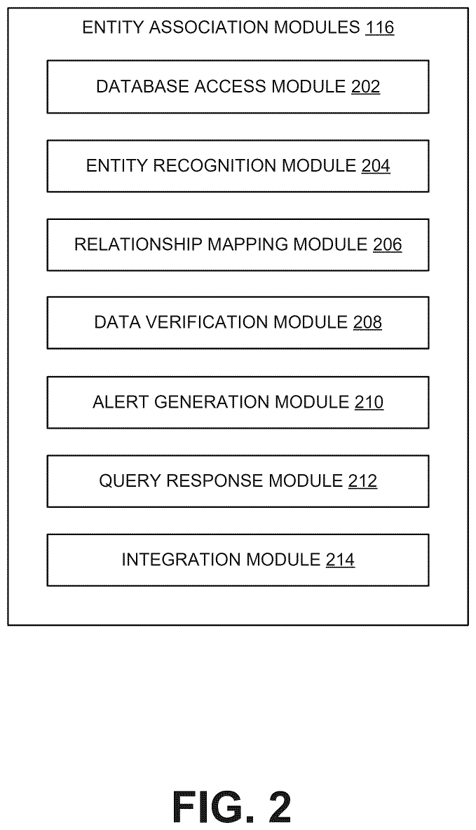

Referring now to FIG. 2, the affiliation screening modules 116 may include one or more modules to execute various functions for the process of screening individuals for associations with entities such as SOEs and NGOs. Each module may handle specific aspects of the screening process, leveraging advanced data processing capabilities to enhance efficiency and accuracy. As illustrated in FIG. 2, the affiliation screening modules 116 may include on or more of a database access module 202, an entity recognition module 204, a relationship mapping module 206, a data verification module 208, an alert generation module 210, a query response module 212, and/or an integration module 214.

The database access module 202 may provide a gateway for accessing and maintaining a comprehensive database of known entities, such as SOEs and NGOs. This database access module 202 may continuously interface with an array of public and proprietary sources to retrieve and update the entity data, ensuring that the repository of the affiliation screening system 102 reflects the most current information available. The database access module 202 may continuously retrieve and update entity data through scheduled and event-driven updates, ensuring the affiliation screening system 102 always contains the latest information. For example, the database access module 202 may regularly pull data from government public records and integrate updates from subscription-based services such as corporate financial databases. This continuous interface may address the challenges faced by conventional systems of data obsolescence by maintaining the accuracy of compliance and risk management processes.

Moreover, database access module 202 may monitor changes in the status or characteristics of entities within the database. For example, the database access module 202 may employ sophisticated monitoring algorithms to continuously track changes in the status or characteristics of entities within its database, focusing particularly on shifts in ownership structures of SOEs or operational changes in NGOs. This database access module 202 may use event-driven triggers and polling mechanisms to detect updates in real-time from interconnected data feeds, such as business registries, news aggregators, and/or legal announcement platforms. For example, if a major shareholder in an SOE changes, or an NGO launches a new program, the associated changes may be captured by analyzing variations in structured data feeds and unstructured content such as news articles or financial reports. The database access module 202 may then update these details within the database 110, ensuring that the information remains current. This continuous monitoring and updating may maintain the accuracy of the data and/or enhance the reliability and relevance of the outcomes produced by the affiliation screening system 102, providing stakeholders with dependable insights for risk assessment and compliance verification.

Furthermore, the database access module 202 may optimize the efficiency of data retrieval processes by employing caching and indexing techniques that speed up query responses. By caching frequently accessed data, the database access module 202 may minimize delays in retrieving information about entities such as SOEs and NGOs. This minimization of delays may be important during live compliance assessments where decision-making speed is essential. For example, when a compliance officer queries the current status of an NGO, the affiliation screening system 102 may quickly deliver the information from cache without needing to perform a full database search. Moreover, indexing of database contents may ensure that even complex queries involving multiple attributes of entities are processed swiftly. Indexing may optimize the structure of the database 110, allowing for rapid traversals and data lookups, which may be particularly beneficial in dynamic risk management scenarios where time-sensitive updates need to be reflected immediately in the outputs 114. This strategic use of caching and indexing may preserve the responsiveness of the affiliation screening system 102, making it highly effective in environments that demand quick access to large volumes of updated data.

The entity recognition module 204 may use one or more NLP algorithms to scan a diverse array of digital media sources for mentions of entities. For example, the entity recognition module 204 may extract relevant information from unstructured text data, such as news articles, blog posts, and financial reports. By using named entity recognition and/or contextual analysis, the entity recognition module 204 may identify and categorize mentions of individuals and their associated roles within organizations, distinguishing relevant entity mentions from irrelevant ones.

In some embodiments, the entity recognition module 204 may use dependency parsing and/or semantic analysis to deeply understand the context within which entities are mentioned in various texts. These techniques allow the entity recognition module 204 to parse complex sentence structures and determine the relationships and roles associated with named entities. For example, if a text states “Jane Doe, serving as an advisor to XYZ Corporation,” the entity recognition module 204 may use semantic analysis to recognize “Jane Doe” as an individual linked to “XYZ Corporation” with an “advisor” role. Dependency parsing may help map out the grammatical relationships in the sentence, confirming that “Jane Doe” is the subject connected to the action “serving,” which directly relates to the entity “XYZ Corporation.” This context-aware analysis ensures that each entity mention is understood in its correct relational and functional capacity, thereby enhancing the precision and relevance of the data extracted for use in compliance and risk assessments within the affiliation screening system 102.

Moreover, the entity recognition module 204 may be continuously updated with the latest developments in NLP technology, ensuring that it remains effective even as language use evolves. One or more machine learning models may be regularly trained on new datasets, encompassing emerging vocabularies, slang, and/or evolving language patterns captured from a broad spectrum of digital media sources, such as social media updates, news articles, and academic journals. For example, as new terms or organization names become prevalent in media discourse (e.g., newly formed NGOs or startups), the NLP models may be updated to recognize these terms accurately. This ongoing training process may include transfer learning, where a pre-trained model is fine-tuned with new data, thereby enabling the entity recognition module 204 to adapt to changes in language use without requiring a rebuild from scratch. This approach ensures that the entity recognition remains robust, reducing the risk of misidentifications and improving the reliability of data used for assessing affiliations and compliance risks.

The relationship mapping module 206 may use text link analysis to delve deeper into the connections identified by the entity recognition module 204. For example, detailed relational graphs may be constructed by the relationship mapping module 206 that visually and conceptually map the connections between entities and individuals. These graphs may uncover both direct associations and indirect relationships that might influence risk assessments and compliance evaluations.

By synthesizing data from various sources and mapping out complex networks, the relationship mapping module 206 may provide a comprehensive view of the relational dynamics within and across entities. For example, if an article mentions that Company A has acquired a stake in Company B, the relationship mapping module 206 may identify both companies as nodes and create an edge representing the acquisition. The relationship mapping module 206 may also analyze the sentiment and strength of the relationship based on the language used in the text. The relational graphs may be updated as new data enters the affiliation screening system 102, ensuring that the visualizations reflect the current state of relationships and allowing for the immediate identification of network changes that might affect regulatory compliance or risk exposure.

In some embodiments, the relationship mapping module 206 may assess the strength and relevance of relationships depicted in the constructed relational graphs by analyzing the frequency and context of entity interactions across various digital media sources. For example, the relationship mapping module 206 may use frequency analysis to gauge the number of times two entities are mentioned together within a set timeframe, which may suggest a stronger relationship. Contextual analysis may further refine the frequency analysis by examining the nature of the mentions, such as collaborative projects or legal disputes, using NLP techniques to determine the sentiment and implications of the interactions. Based on these assessments, the relationship mapping module 206 may assign weights to the edges in the relational graph, effectively prioritizing relationships that have a higher potential impact on the risk profile associated with the entity. This prioritization may enable risk managers and compliance officers to focus their efforts on monitoring and mitigating risks associated with the most critical or vulnerable connections, such as a frequent partnership between a firm and a politically exposed person which might expose the firm to increased scrutiny and regulatory risk.

The data verification module 208 may provide a safeguard by verifying the accuracy and consistency of the information extracted by other modules of the one or more affiliation screening modules 116. Moreover, the data verification module 208 may use validation algorithms and heuristic checks to ensure data integrity by cross-referencing identified entities and their relationships against multiple trusted sources. For example, after entities and relationships are identified by the entity recognition module 204, the data verification module 208 may cross-references this information against multiple trusted sources such as official government registries, well-established news databases, and verified corporate disclosures. The entity recognition module 204 may detect discrepancies and inconsistencies by comparing the extracted data with authoritative records, ensuring that entity names, roles, and connections are accurately matched and up-to-date. Heuristic checks may include rules-based assessments that flag potential anomalies, such as an individual being listed in a role for a company from which they have publicly resigned. This verification process may prevent the propagation of errors and ensures that the outputs 114 remain reliable and trustworthy, significantly reducing the risk of decisions based on outdated or incorrect information.

The data verification module 208 may maintain and enhance the accuracy of the data within the database 110 by continuously monitoring and identifying discrepancies or anomalies in the entity data. In some embodiments, the data verification module 208 may systematically review entity information against updated external sources, such as business registries or news feeds, to detect and rectify inconsistencies. For example, if an entity is reported as dissolved in a government update but is still active in the database 110, the data verification module 208 may trigger a corrective action to align the database 110 with the most recent information. This proactive approach may ensure the integrity of the data used by the affiliation screening system 102. Moreover, the data verification module 208 may may use real-time data validation techniques, such as checksums or hash sums, to verify the correctness of data after each update, automatically correcting errors such as typographical mistakes or outdated entity statuses.

Furthermore, the data verification module 208 may use machine learning techniques to improve its error detection and correction capabilities over time. By analyzing patterns and outcomes from historical corrections and adjustments, the data verification module 208 may train its algorithms to better recognize and autonomously rectify frequent and recurring data inconsistencies. For example, using a supervised learning approach, the data verification module 208 may be trained on a dataset comprising instances of common errors such as misclassified entity types or incorrectly linked entity profiles, alongside corrected versions. Over time, the machine learning models may learn to predict these errors and suggest or automatically apply the most likely correction, thus increasing overall data accuracy and operational efficiency. This method not only minimizes human intervention but also ensures the database 110 maintains high integrity for effective compliance and risk management.

The alert generation module 210 may increase the responsiveness of the affiliation screening system 102 by actively monitoring variations in the relationships and statuses of entities recorded in the database. In some embodiments, the alert generation module 210 may may create automated alerts that trigger notifications upon detecting changes within the entity data. For example, should there be an appointment of a new director in an NGO or a modification in the ownership structure of an SOE, the alert generation module 210 may assess the changes against predefined criteria to determine their significance. Based on event detection and/or continuous data streaming, the alert generation module 210 may ensure that any substantial updates are communicated by using complex event processing to detect, analyze, and respond to business events in real time. Thereby, the alert generation module 210 may facilitate immediate, informed actions to manage emerging compliance risks or adjustments in the broader risk profile, aiding in proactive risk management and compliance adherence.

Alerts generated by the alert generation module 210 may be configured to be both informative and actionable. The alerts may provide detailed information about the nature of the change and its potential implications, allowing compliance officers and risk managers to quickly assess the situation and decide on appropriate actions. The alerts may be formatted to include links to affected records, historical data comparisons, and/or determined risk assessment scores that quantify the urgency and impact of the change. For example, if a new director is appointed in an NGO, an alert may provide a brief profile of the director, related legal and compliance checks, and/or any past incidents that might influence risk assessments. This detailed, contextual information may allow compliance officers and risk managers to swiftly understand and react to new developments, supporting proactive strategies by facilitating early interventions and preventing potential compliance issues before they escalate.

Additionally, the alert generation module 210 may use customizable alert settings to tailor notifications according to user preferences and specific operational requirements. Users may configure the affiliation screening system 102 to monitor specific types of changes, such as shifts in executive leadership, regulatory status updates, or significant financial transactions, and/or adjust the sensitivity of the triggers to match their risk tolerance and compliance frameworks. According to some embodiments, the user interface module 118 may provide an interface (e.g., to computing devices 104) where parameters such as alert thresholds, change magnitudes, and/or the frequency of occurrence can be set. For example, a financial institution may set high sensitivity for changes in ownership structures of partnered SOEs to ensure immediate notification, while a smaller NGO may opt for alerts only for significant operational changes like mergers or acquisitions. This customization may ensure that the alerts are not only relevant but also aligned with the specific risk management strategies of the user, enhancing the overall operational effectiveness of the affiliation screening system 102 by preventing alert fatigue and focusing attention on truly significant events.

The query response module 212 may provide an interface for handling external inquiries related to specific entities or their interrelationships. When a query is received, the query response module 212 may access the database 110 to pull relevant information, e.g., including historical data, current statuses, and detailed profiles of entities. The query response module 212 may use indexing and/or search algorithms to expedite data retrieval and quickly provide comprehensive results. For example, if a compliance officer queries the involvement of a person in any NGO, the query response module 212 may search the entity data, compile a report detailing the individual's roles across various organizations over time, and present the report in a structured format (e.g., including timelines and/or relationship maps). Thereby, the query response module 212 may support rigorous compliance reviews and risk assessments by providing stakeholders with detailed, ready-to-analyze data, facilitating informed decision-making and thorough investigations.

The query response module 212 may utilize advanced search algorithms and query optimization techniques to ensure that responses are accurate and timely, minimizing wait times and maximizing the relevance of the information provided. For example, when processing a query about a specific NGO's affiliations, the query response module 212 may use indexed keywords and relationship tags to pull relevant data in near real-time. Moreover, query optimization strategies such as caching frequently requested data and/or predictive analytics may be used to pre-fetch data based on common query patterns.

In some embodiments, the query response module 212 may use query tracking and data analytics to log and analyze each inquiry it processes. The data analytics may categorize queries by type, frequency, and complexity. For example, the query response module 212 may track how often users inquire about specific types of entities or relationships, and analyze patterns or spikes in query types during certain periods. This data may then used to refine the query response module 212 by optimizing response strategies for common queries and adjusting resource allocation to handle high-demand periods more efficiently. Additionally, insights from query analytics may guide updates to the structure of the database 110 and/or refine screening algorithms to better match emerging compliance needs and industry trends, ensuring that the affiliation screening system 102 adapts to changing user requirements and maintains optimal performance.

The integration module 214 may provide seamless integration of the affiliation screening modules 116 with external compliance systems to create a unified and effective risk management framework. By ensuring coherent data flow and synchronization across various platforms, the integration module 214 may supports a collaborative approach to compliance, where information and insights are shared efficiently across different parts of the organization. In some embodiments, the integration module 214 may use standardized APIs and/or data exchange protocols, such as RESTful APIs or SOAP, to transmit and receive data efficiently across different software platforms, allowing the integration module 214 to integrate with a wide range of databases and compliance tools regardless of their underlying technology. For example, the integration module 214 may connect with CRM (Customer Relationship Management) systems, financial tracking applications, or other regulatory compliance databases. By ensuring compatibility and simplifying the data sharing process, the integration module 214 may enhance the operational flexibility of the affiliation screening system 102, enabling organizations to consolidate and utilize diverse technological resources effectively, thereby optimizing their compliance and risk management strategies.

In some embodiments, the integration module 214 may use security features to protect data integrity and confidentiality during exchanges. The security features may include use of SSL/TLS encryption for data in transit to ensure that all data sent and received by the integration module 214 is encrypted and secure from interception. Moreover, the integration module 214 may use OAuth for secure, token-based user authentication to control access and ensure that only authorized users can interact with the affiliation screening system 102. In some embodiments, the integration module 214 may use data masking and/or anonymization to protect sensitive information, such as personal identifiers, from exposure even if the data is intercepted or improperly accessed. These security features may prevent data breaches, maintain regulatory compliance with laws such as GDPR or HIPAA, and protect organizations from potential legal consequences and reputational harm that could arise from data mishandling.

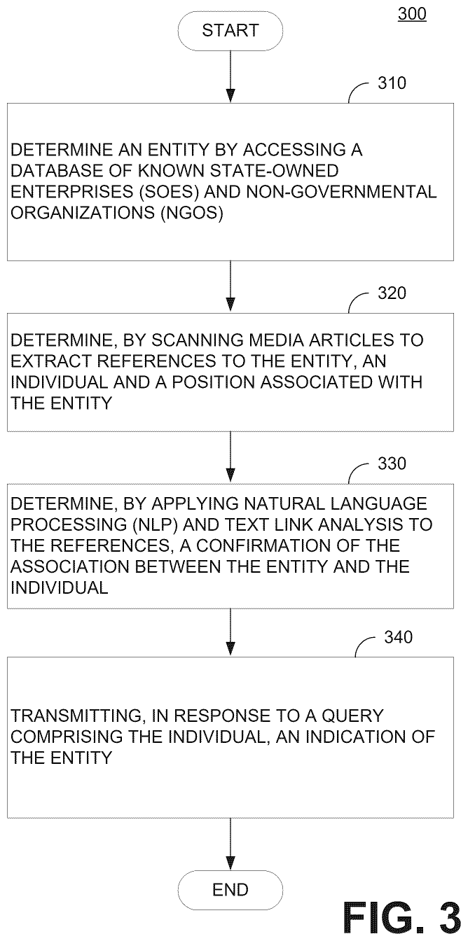

Referring now to FIG. 3, illustrated is a flowchart of a process 300, according to an aspect of the disclosed systems and processes. The process 300 may demonstrate a method for identifying and confirming associations between individuals and entities such as SOEs and NGOs. Moreover, the process 300 may leverage data analytics technologies to streamline and enhance the screening process.

At step 310, the process 300 may include accessing a comprehensive and regularly updated database containing detailed information on known SOEs and NGOs. The database may include data from various public and proprietary sources. Moreover, the database may be dynamic, accommodating updates and changes to entity information to reflect real-time global changes, such as new NGOs being registered or changes in the ownership structure of SOEs. By establishing a reliable database of entities, the process 300 may reduce errors in the association screening, allowing for quick retrieval and cross-referencing of entity data during the screening process and facilitating a seamless flow of information.

At step 320, the process 300 may scan through a vast array of media articles to extract references to the entities. The scanning may include parsing through digital newspapers, blogs, financial reports, and other media sources to identify mentions of SOEs and NGOs and the individuals associated with them. NLP technology may be used to sift through large volumes of text data efficiently, ensuring that all relevant information is captured. Moreover, step 320 may gather comprehensive data about how entities and associated individuals are represented in the media.

The extracted data from may include names, positions, and/or contextual information that may indicate the nature of the individual's association with the entity. For example, the system may identify whether an individual is mentioned as a board member, a donor, or in any other capacity that links them to the entity. This level of detail may allow the process 300 to build accurate profiles of associations for effective compliance checks and risk measurements.

At step 330, the process 300 may apply a combination of NLP and text link analysis techniques to the references gathered in step 320 to confirm the association between entities and individuals. The confirmation may include detailed examination of the textual context in which the names and references appear and may include distinguishing between substantive connections and incidental mentions. For instance, the process 300 may assess whether a mentioned individual holds a significant role within the entity or if their connection is superficial or unrelated to the entity's core activities. Step 330 may increase reliability of the screening process by minimizing false positives, which may be common in conventional systems. By analyzing the context and the specific language used in the references, the process 300 may determine the strength and relevance of each association. This determination may include assessing the sentiment and tone of the mentions, which may provide deeper insights into the nature of the relationship between the individual and the entity.

At step 340, the process 300 may transmit, in response to specific queries, indications of the entities associated with an individual. For example, step 340 may provide users, such as compliance officers or risk managers, with precise and actionable information that enables effective decision-making. The indications may include comprehensive profiles that outline the individual's role within the entity, the nature of their association, and/or any other relevant details uncovered in the process 300. Moreover, transmission of information may be tailored to the specific needs of the users, providing the users with data and/or contextually enriched insights that aid in compliance and risk measurement. The output from step 340 may be used for making informed decisions about whether further investigation is needed or if any immediate actions should be taken based on the associations identified.

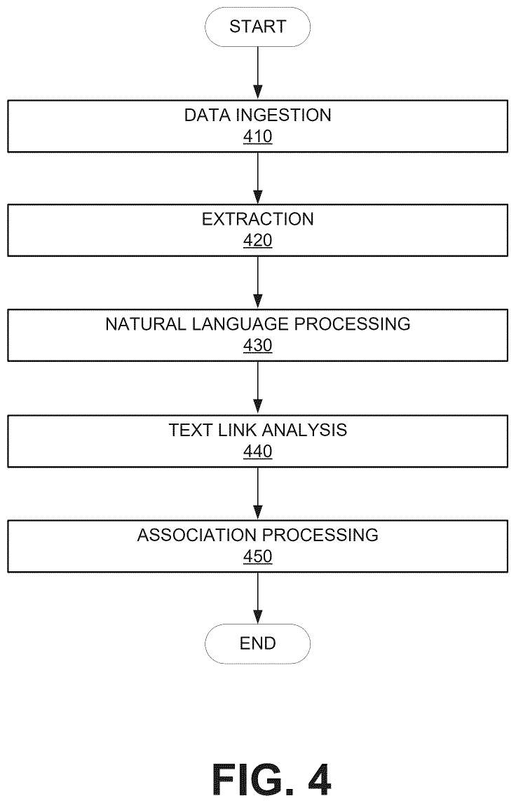

Referring now to FIG. 4, illustrated is a flowchart of a process 400, according to an aspect of the disclosed systems and processes. The process 400 may demonstrate a method for identifying and verifying associations between individuals and entities, utilizing one or more data processing techniques. Moreover, the process 400 may provide a thorough examination of data from various sources, applying advanced analytics to enhance the reliability and effectiveness of the affiliation screening system.

At step 410 (e.g., DATA INGESTION), the process 400 may collect a wide range of data from diverse sources. The data may include digital media, public records, proprietary databases, etc., ensuring a comprehensive dataset that covers all relevant information on entities such as SOEs and NGOs. Step 410 may collect high volumes of data in various formats, enabling the process 400 to maintain an up-to-date and extensive database for analysis. Automated tools may scan and pull information from the designated sources, categorizing it appropriately for easy access in subsequent stages. The automation may speed up the process and reduce human error, facilitating a more reliable and systematic approach to data collection.

At Step 420 (e.g., EXTRACTION), the process 400 may parse the ingested data to identify specific pieces of information that are relevant to the screening process. For example, step 420 may isolate names, locations, dates, and other pertinent details from the raw data. One or more algorithms and extraction techniques may be used to sift through the data, pulling out relevant information while discarding irrelevant or redundant data. Moreover, targeted extraction may be used to manage vast amounts of processed data, providing useful information for other steps of the process 400. Step 420 may be tailored to recognize and interpret the varied formats and structures of data, from structured databases to unstructured text in news articles or reports. This flexibility may allow the process 400 to adapt to different data sources, providing comprehensive coverage and reducing the chances of overlooking critical information.

At step 430 (e.g., NLP), the extracted data may undergo linguistic and semantic analysis to understand and interpret the context in which information appears. NLP techniques such as tokenization, named entity recognition, and sentiment analysis may be applied to analyze the text. Moreover, step 430 may determine the significance and relevance of the extracted information, allowing the process 400 to differentiate between meaningful associations and incidental mentions. NLP may also facilitate the identification of complex relationships within the data, such as the roles of individuals in relation to specific entities. By analyzing language patterns and structures, the process 400 may uncover subtle nuances that may indicate underlying connections, providing a deeper understanding of the data. Accordingly, step 430 may include a comprehensive linguistic analysis, ensuring that the information used in the decision-making process is accurate and contextually relevant.

At step 440 (e.g., TEXT LINK ANALYSIS), the process 400 may build on the findings from step 430 to map out and visualize the relationships and connections identified among entities and individuals. Step 440 may include creating relational graphs and networks that illustrate how different data points are interlinked. For example, text link analysis may help visualize the strength and nature of relationships, which may be instrumental in assessing the potential impact and significance of the connections. Moreover, step 440 may uncover indirect or hidden associations that may not be immediately obvious from straightforward data review. By employing sophisticated algorithms to analyze the links between entities and contextual data points, the process 400 may provide a comprehensive and nuanced view of the relationships, enhancing the depth and quality of the analysis.

At step 450 (e.g., ASSOCIATION PROCESSING) the process 400 may synthesize the insights (e.g., gained from the previous steps) to confirm and document the associations between individuals and entities. Step 450 may include validating the identified connections, ensuring their accuracy and pertinence to the objectives of the screening process. According to some aspects, step 450 may include categorizing the associations based on their nature and potential implications, such as determining whether a relationship poses a compliance risk or represents a benign connection. Moreover, association processing may include translating the analytical findings into actionable intelligence. For example, the process 400 may generate detailed reports and profiles that can be used by compliance officers and risk managers to make informed decisions. The outputs of process 400 may be easily interpretable, providing clear and concise information that aids in quick and effective decision-making, and may support proactive risk management and compliance efforts.

The machine learning model may leverage the insights gained from the association processing to refine and enhance the model's accuracy and reliability. This training process may begin with the collection of labeled data from the validated associations, which serves as a high-quality training dataset. The machine learning model may then be trained using supervised learning techniques, where algorithms such as Support Vector Machines (SVM), Random Forest, or Neural Networks may be employed to learn patterns and relationships from the data. During training, the machine learning model may undergo iterative optimization, adjusting its parameters to minimize prediction errors. Cross-validation may be used to ensure the model generalizes well to new data, preventing overfitting.

Additionally, the machine learning model may incorporate feedback loops, where user feedback on the predictions of the machine learning model may be continuously integrated to further refine the performance of the machine learning model. This feedback mechanism may allow the machine learning model to adapt to new data patterns and regulatory changes dynamically. The training process may also include the use of advanced NLP techniques, such as named entity recognition and sentiment analysis, to enhance the ability of the machine learning model to interpret and contextualize data accurately. By continuously updating the training dataset with new and relevant data, the machine learning model may evolve, improving the predictive capabilities of the machine learning model and ensuring that the affiliation screening system 102 remains effective in identifying and verifying associations between individuals and entities.

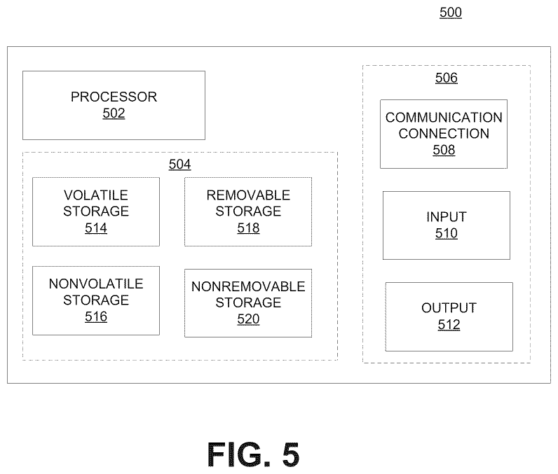

FIG. 5 is a block diagram of a computing device 500 that may be connected to or comprise a component of affiliation screening system 102, computing devices 104, server 108, and/or database 110. Computing device 500 may comprise hardware or a combination of hardware and software. The functionality to facilitate association screening may reside in one or a combination of computing devices 500. Computing device 500 depicted in FIG. 5 may represent or perform functionality of an appropriate computing device 500, or a combination of computing devices 500, such as, for example, a component or various components of an association screening system, a computing device, a processor, a server, a gateway, a database, a firewall, a router, a switch, a modem, an encryption tool, a virtual private network (VPN), or the like, or any appropriate combination thereof. It is emphasized that the block diagram depicted in FIG. 5 is an example and is not intended to imply a limitation to a specific example or configuration. Thus, computing device 500 may be implemented in a single device or multiple devices (e.g., single server or multiple servers, single gateway or multiple gateways, single controller, or multiple controllers). Multiple network entities may be distributed or centrally located. Multiple network entities may communicate wirelessly, via hard wire, or any appropriate combination thereof.

Embodiments of the computing device 500 may comprise a processor 502 and a memory 504 coupled to processor 502. The memory 504 may contain executable instructions that, when executed by the processor 502, may cause the processor 502 to effectuate operations associated with association screening. As evident from the description herein, the computing device 500 is not to be construed as software per se.

In addition to a processor 502 and memory 504, a computing device 500 may include an input/output system 506. The processor 502, memory 504, and input/output system 506 may be coupled together (coupling not shown in FIG. 5) to allow communications between them. Each portion of the computing device 500 may comprise circuitry for performing functions associated with each respective portion. Thus, each portion may comprise hardware, or a combination of hardware and software. Accordingly, each portion of a computing device 500 is not to be construed as software per se. An input/output system 506 may be capable of receiving or providing information from or to a communications device or other network entities configured for association screening. For example, the input/output system 506 may include a wireless communication (e.g., 3G/4G/5G/GPS) card. The input/output system 506 may be capable of receiving or sending video information, audio information, control information, image information, data, or any combination thereof. Input/output system 506 may be capable of transferring information with the computing device 500. In various configurations, the input/output system 506 may receive or provide information via any appropriate means, such as, for example, optical means (e.g., infrared), electromagnetic means (e.g., RF, Wi-Fi, Bluetooth®, ZigBee®), acoustic means (e.g., speaker, microphone, ultrasonic receiver, ultrasonic transmitter), or a combination thereof. In an example configuration, the input/output system 506 may comprise a Wi-Fi finder, a two-way GPS chipset or equivalent, or the like, or a combination thereof.

Embodiments of the input/output system 506 of computing device 500 also may contain a communication connection 508 that allows the computing device 500 to communicate with other devices, network entities, or the like. The communication connection 508 may comprise communication media. Communication media may typically embody computer-readable instructions, data structures, program modules or other data in a modulated data signal such as a carrier wave or other transport mechanism and may include any information delivery media. By way of example, and not limitation, communication media may include wired media such as a wired network or direct-wired connection, or wireless media such as acoustic, RF, infrared, or other wireless media. The term computer-readable media as used herein includes both storage media and communication media. The input/output system 506 also may include an input device 510 such as keyboard, mouse, pen, voice input device, or touch input device. The input/output system 506 may also include an output device 512, such as a display, speakers, or a printer.

Embodiments of the processor 502 may be capable of performing functions associated with association screening, such as functions for automated processing and analysis of vast amounts of unstructured data to conduct precise, contextually relevant screenings for affiliations with entities such as SOEs and NGOs, as described herein. For example, a processor 502 may be capable of, in conjunction with any other portion of the computing device 500, natural language processing and text link analysis in association screening, as described herein.

Embodiments of a memory 504 of the computing device 500 may comprise a storage medium having a concrete, tangible, physical structure. As is known, a signal does not have a concrete, tangible, physical structure. The memory 504, as well as any computer-readable storage medium described herein, is not to be construed as a signal. The memory 504, as well as any computer-readable storage medium described herein, is not to be construed as a transient signal. The memory 504, as well as any computer-readable storage medium described herein, is not to be construed as a propagating signal. The memory 504, as well as any computer-readable storage medium described herein, is to be construed as an article of manufacture.

The memory 504 may store any information utilized in conjunction with association screening. Depending upon the exact configuration or type of processor, a memory 504 may include a volatile storage 514 (such as some types of RAM), a nonvolatile storage 516 (such as ROM, flash memory), or a combination thereof. The memory 504 may include additional storage (e.g., a removable storage 518 or a non-removable storage 520) including, for example, tape, flash memory, smart cards, CD-ROM, DVD, or other optical storage, magnetic cassettes, magnetic tape, magnetic disk storage or other magnetic storage devices, USB-compatible memory, or any other medium that can be used to store information and that can be accessed by a computing device 500. The memory 504 may comprise executable instructions that, when executed by a processor 502, cause the processor 502 to effectuate operations associated with association screening.

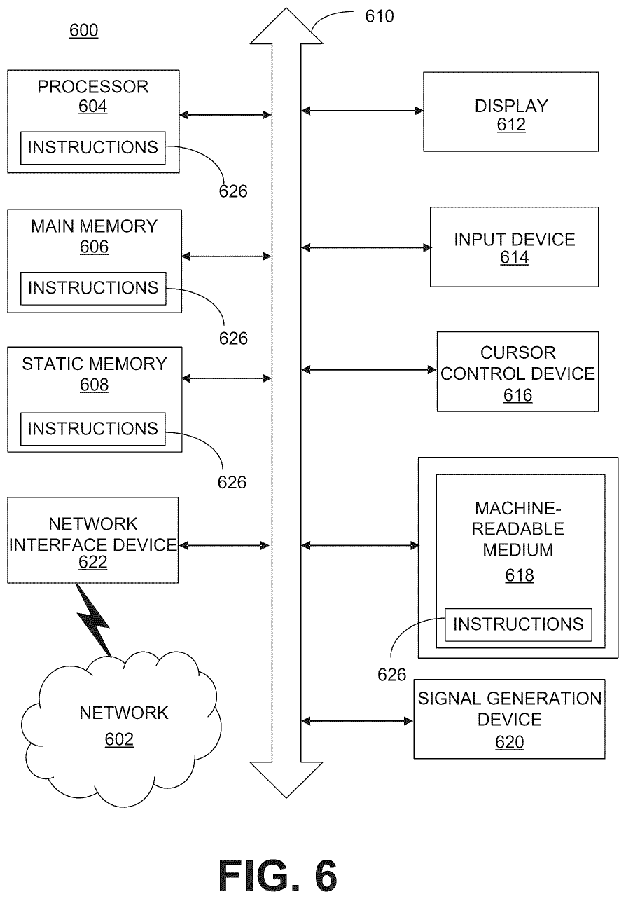

FIG. 6 depicts an example of a diagrammatic representation of a machine in the form of a computer system 600 within which a set of instructions, when executed, may cause the machine to perform any one or more of the methods described above. One or more instances of the machine can operate, for example, as computing device 500, processor 502, processor 604, affiliation screening system 102, computing devices 104, server 108, database 110, and other devices of FIGS. 1-5. In some examples, the machine may be connected (e.g., using a network 602) to other machines. In a networked deployment, the machine may operate in the capacity of a server or a client user machine in a server-client user network environment, or as a peer machine in a peer-to-peer (or distributed) network environment.

The machine may comprise a server computer, a client user computer, a personal computer (PC), a tablet, a smart phone, a laptop computer, a desktop computer, a control system, a network router, switch or bridge, or any machine capable of executing a set of instructions (sequential or otherwise) that specify actions to be taken by that machine. It will be understood that a communication device of the subject disclosure includes broadly any electronic device that provides voice, video, or data communication. Further, while a single machine is illustrated, the term “machine” shall also be taken to include any collection of machines that individually or jointly execute a set (or multiple sets) of instructions to perform any one or more of the methods discussed herein.

A computer system 600 may include a processor (or controller) 604 (e.g., a central processing unit (CPU)), a graphics processing unit (GPU, or both), a main memory 606 and a static memory 608, which communicate with each other via a bus 610. The computer system 600 may further include a display unit 612 (e.g., a liquid crystal display (LCD), a flat panel, or a solid-state display). The computer system 600 may include an input device 614 (e.g., a keyboard), a cursor control device 616 (e.g., a mouse), a disk drive unit 618, a signal generation device 620 (e.g., a speaker or remote control) and a network interface device 622. In distributed environments, the examples described in the subject disclosure can be adapted to utilize multiple display units 612 controlled by two or more computer systems 600. In this configuration, presentations described by the subject disclosure may in part be shown in a first of display units 612, while the remaining portion is presented in a second of display units 612.

The disk drive unit 618 may include a tangible computer-readable storage medium on which is stored one or more sets of instructions (e.g., instructions 626) embodying any one or more of the methods or functions described herein, including those methods illustrated above. Instructions 626 may also reside, completely or at least partially, within the main memory 606, the static memory 608, or within the processor 604 during execution thereof by the computer system 600. The main memory 606 and the processor 604 also may constitute tangible computer-readable storage media.

While examples of a system for association screening have been described in connection with various computing devices/processors, the underlying concepts may be applied to any computing device, processor, or system capable of facilitating an association screening system. The various techniques described herein may be implemented in connection with hardware or software or, where appropriate, with a combination of both. Thus, the methods and devices may take the form of program code (i.e., instructions) embodied in concrete, tangible, storage media having a concrete, tangible, physical structure. Examples of tangible storage media include floppy diskettes, CD-ROMs, DVDs, hard drives, or any other tangible machine-readable storage medium (computer-readable storage medium). Thus, a computer-readable storage medium is not a signal. A computer-readable storage medium is not a transient signal. Further, a computer readable storage medium is not a propagating signal. A computer-readable storage medium as described herein is an article of manufacture. When the program code is loaded into and executed by a machine, such as a computer, the machine becomes a device for association screening. In the case of program code execution on programmable computers, the computing device will generally include a processor, a storage medium readable by the processor (including volatile or nonvolatile memory or storage elements), at least one input device, and at least one output device. The program(s) can be implemented in assembly or machine language, if desired. The language can be a compiled or interpreted language and may be combined with hardware implementations.

The methods and devices associated with an association screening system as described herein also may be practiced via communications embodied in the form of program code that is transmitted over some transmission medium, such as over electrical wiring or cabling, through fiber optics, or via any other form of transmission, wherein, when the program code is received and loaded into and executed by a machine, such as an erasable programmable read-only memory (EPROM), a gate array, a programmable logic device (PLD), a client computer, or the like, the machine becomes a device for association screening as described herein. When implemented on a general-purpose processor, the program code combines with the processor to provide a unique device that operates to invoke the functionality of an association screening system.

While the disclosed systems have been described in connection with the various examples of the various figures, it is to be understood that other similar implementations may be used, or modifications and additions may be made to the described examples of an association screening system without deviating therefrom. For example, one skilled in the art will recognize that an association screening system as described in the instant application may apply to any environment, whether wired or wireless, and may be applied to any number of such devices connected via a communications network and interacting across the network. Therefore, the disclosed systems as described herein should not be limited to any single example, but rather should be construed in breadth and scope in accordance with the appended claims.

In describing preferred methods, systems, or apparatuses of the subject matter of the present disclosure—automatically processing and analyzing vast amounts of unstructured data to provide accurate, contextually relevant association screening—as illustrated in the Figures, specific terminology is employed for the sake of clarity. The claimed subject matter, however, is not intended to be limited to the specific terminology so selected. In addition, the use of the word “or” is generally used inclusively unless otherwise provided herein.

This written description uses examples to enable any person skilled in the art to practice the claimed subject matter, including making and using any devices or systems and performing any incorporated methods. Other variations of the examples are contemplated herein.

What is claimed:

1. One or more computing devices, comprising one or more processors, configured to:
determine an entity by accessing a database of known state-owned enterprises (SOEs) and non-governmental organizations (NGOs);
determine, by scanning a plurality of media articles to extract references to the entity, an individual and a position associated with the entity;
determine, by applying natural language processing (NLP) and text link analysis to the references, a confirmation of the association between the entity and the individual; and
transmit, in response to a query comprising the individual, an indication of the entity.

2. The one or more computing devices of claim 1, further configured to update, based on the confirmation, a profiled database with the association between the entity and the individual.

3. The one or more computing devices of claim 2, further configured to trigger an alert based on a change in a status of the association between the entity and the individual.

4. The one or more computing devices of claim 2, wherein the association between the entity and the individual are tagged in the profiled database.

5. The one or more computing devices of claim 1, wherein the indication of the entity comprises the position associated with the entity.

6. The one or more computing devices of claim 1, wherein the query is associated with measuring compliance and risk.

7. The one or more computing devices of claim 1, wherein the database of known SOEs and NGOs is compiled from a plurality of public and proprietary sources.

8. The one or more computing devices of claim 1, wherein the entity and the position are referenced by the plurality of media articles in a same context.

9. The one or more computing devices of claim 1, further configured to determine, based on applying a machine learning model to historical data patterns, a likelihood of an ongoing association of the individual with the entity.

10. The one or more computing devices of claim 1, further configured to determine a geopolitical risk factor based on a locations associated with the entity or the individual, wherein the indication of the entity is further based on the geopolitical risk factor.

11. The one or more computing devices of claim 1, wherein the text link analysis comprises determining a relational graph comprising a connection between the entity and the individual.

12. The one or more computing devices of claim 1, wherein the NLP further comprises parsing the references for regulatory terms indicating compliance risks associated with the entity.

13. The one or more computing devices of claim 1, further configured to determine a category for the association between the entity and the individual, wherein the indication of the entity comprises the category.

14. The one or more computing devices of claim 1, wherein the media articles include comprise digital media.

15. The one or more computing devices of claim 1, wherein the individual and the position associated with the entity are determined, at least in part, using a machine learning model.

16. The one or more computing devices of claim 1, further configured to integrate with external compliance systems for collaborative risk management.

17. The one or more computing devices of claim 1, wherein updates to the database are automatically performed at predetermined intervals or in real-time as new information becomes available.

18. The one or more computing devices of claim 1, further configured to determine potential conflicts of interest associated with the individual and the entity based on historical associations and current associations.

19. A method performed by one or more computing devices, the method comprising:
determining an entity by accessing a database of known state-owned enterprises (SOEs) and non-governmental organizations (NGOs);
determining, by scanning a plurality of media articles to extract references to the entity, an individual and a position associated with the entity;
determining, by applying natural language processing (NLP) and text link analysis to the references, a confirmation of the association between the entity and the individual; and
transmitting, in response to a query comprising the individual, an indication of the entity.

20. A system comprising:
one or more processors; and
memory coupled with the one or more processors, the memory storing executable instructions that when executed by the one or more processors cause the one or more processors to effectuate operations comprising:
determining an entity by accessing a database of known state-owned enterprises (SOEs) and non-governmental organizations (NGOs);
determining, by scanning a plurality of media articles to extract references to the entity, an individual and a position associated with the entity;
determining, by applying natural language processing (NLP) and text link analysis to the references, a confirmation of the association between the entity and the individual; and
transmitting, in response to a query comprising the individual, an indication of the entity.
